(19) United States
(12) Patent Application Publication
(10) Pub. No.: US 2021/0062522 A1
(43) Pub. Date: Mar. 4, 2021

(54) TILE LAYING DEVICES

(71) Applicant: Invention Holdings Pty Ltd, West Burleigh (AU)

(72) Inventor: Peter Castellanos, West Burleigh (AU)

(21) Appl. No.: 16/995,518

(22) Filed: Aug. 17, 2020

(30) Foreign Application Priority Data
Sep. 2, 2019 (AU) 2019903233

(51) Int. Cl. E04F 21/22; E04F 21/00; G01C 9/00

(52) U.S. Cl. CPC E04F 21/22; G01C 9/00; E04F 21/0092

(57) ABSTRACT

A tile laying device that has a flange on which edge portions of two or more adjacent tiles can be positioned and a web that extends from the flange, the web defining an opening. A levelling member defines a proximal surface and a distal surface, the proximal surface being configured to diverge from the distal surface so that, when the levelling member is positioned in the opening of the web and the edge portions are positioned on the flange, displacement of the levelling member relative to the tile laying device results in the distal surface bearing against the edge portions. A spacing block can be interposed between the distal surface of the levelling member and the edge portions of the two or more adjacent tiles, the spacing block and the levelling member are releasably engageable with each other.

### FIELD OF THE INVENTION

This invention relates to tile laying devices. More particularly, but not exclusively, the invention relates to a tile laying accessory for a tile laying device that can be used to assist the laying of tiles and other building elements in an orderly and neat manner. The invention also relates to a tile laying system and to a method of laying tiles, using the tile laying accessory.

### BACKGROUND TO THE INVENTION

Various tile laying accessories or devices are currently available that assist in the laying of tiles in an orderly and neat manner. A number of these include a flange on which edge portions of two adjacent tiles can be positioned. A web extends from the flange between the adjacent tiles. The web includes two spaced stems and a bridge member that interconnects the stems so that the flange, the stems and the bridge member define an opening for receiving a levelling member in the form of a wedge. The wedge has a distal bearing surface that bears on the edge portions of the adjacent tiles and a proximal sloped surface that bears against the bridge member so that the wedge can be driven into the opening such that the distal bearing surface applies pressure to the edge portions. The stems and/or spacers can be used to maintain a gap between the edge portions, while the pressure applied can facilitate adhering of the tiles to a substrate.

Tiles and similar building components are available in a wide variety of thicknesses. This makes it necessary for the tile laying devices to be provided with different sizes. However, it is necessary for separate components such as pieces of timber to be used to lift the wedge so that the proximal sloped surface can engage the bridge member. This can be inconvenient and time-consuming, considering that it needs to be repeated for each set of adjacent tiles that require adhesion or spacing.

### SUMMARY OF THE INVENTION

According to a first aspect of the invention, there is provided an accessory for a tile laying device that has a flange on which edge portions of two or more adjacent tiles can be positioned and a web that extends from the flange, the web defining an opening, the accessory comprising:
a levelling member that defines a proximal surface and a distal surface, the proximal surface being configured to diverge from the distal surface so that, when the levelling member is positioned in the opening of the web and the edge portions are positioned on the flange, displacement of the levelling member relative to the tile laying device results in the distal surface bearing against the edge portions; and
a spacing block that can be interposed between the distal surface of the levelling member and the edge portions of the two or more adjacent tiles, the spacing block and the levelling member being releasably engageable with each other.

Thus, the levelling member and the spacing block can be engaged with each other to provide an assembly that can be used repeatedly during a tile laying process, without the need to repeatedly position a discrete spacing element, such as a piece of timber or the like, between the levelling member and the tiles. The spacing block can be provided in different sizes to suit different thicknesses of tiles or building components. Furthermore, two or more spacing blocks can be used, where required. Thus, the spacing block is configured so that it can be releasably engageable with a further spacing block. For example, the spacing block may be configured similarly to a building block, such as that known as Lego® building blocks.

The levelling member may define one or more recesses that open in the distal surface. The spacing block may have a body. One or more projections may extend from a proximal side of the body. The one or more recesses of the levelling member and the one or more projections of the spacing block may be dimensioned so that the projection(s) can be press-fitted, by hand, into the recess(es) and extracted, by hand, from the recess(es). Thus, the levelling member and the spacing block can be engaged with each other to provide an assembly that can be used repeatedly during a tile laying process, without the need to reposition a separate spacer for each use.

The distal surface of the levelling member may be generally planar. The levelling member may define a single recess in the form of a cavity.

Both the levelling member and the spacing block may be rectangular in plan with opposed minor sides and opposed major sides. The projections of the spacing block may include opposed end projections that are positioned to engage an internal surface of the levelling member at respective ends of the levelling member. For example, each end projection may include a lateral wall that engages the internal surface at the associated minor side and opposed longitudinal walls, extending from the lateral wall, that engage end portions of the internal surface of the major sides, adjacent to said associated minor side. The projections of the spacing block may also include opposed intermediate projections that are positioned intermediate the end projections to engage the internal surface of respective opposite major sides of the levelling member.

The following description of the embodiments shown in the drawings is intended to be described a manner of performing the invention. As such, the following description is not intended to narrow the scope of the appended claims or the preceding paragraphs.

### BRIEF DESCRIPTION OF THE DRAWINGS

FIG. 1 shows a three-dimensional view of a known tile laying device of one size engaged with a levelling member in a conventional manner.

FIG. 2 shows a front view of an embodiment of a further, larger tile laying device engaged with one embodiment of an accessory, in accordance with one aspect of the invention, for the tile laying device.

FIG. 3 shows a three-dimensional view of a spacer block of the accessory of FIG. 2.

FIG. 4 shows a three-dimensional view, from underneath, of a levelling member of the accessory for FIG. 2.

FIG. 5 shows a bottom plan view of the spacer block.

FIG. 6 shows a front view of an embodiment of a tile laying device, in accordance with one aspect of the invention.

FIG. 7 shows a front view of an embodiment of a tile laying device, in accordance with one aspect of the invention.

FIG. 8 shows a side view of an embodiment of a tile laying device, in accordance with one aspect of the invention.

FIG. 9 shows a three-dimensional view of an embodiment of a tile laying device, in accordance with one aspect of the invention, in use

### DETAILED DESCRIPTION

FIG. 1 shows an existing tile laying device 10, used with an existing levelling member in the form of a wedge 12 to space and level consecutive tiles 14. The tile laying device 10 includes a flange (not shown). A web 16 extends from the flange, between the adjacent tiles 14. The web 16 includes two spaced stems 18 and a bridge member 20 that interconnects the stems 18 so that the flange, the stems 18 and the bridge member 20 define an opening 22 for receiving the wedge 12.

An edge portion 24.1 of one tile 14.1 rests on a front portion of the flange and an edge portion 24.2 of an adjacent tile 14.2 rests on a rear portion of the flange, such that the stems 18 extend between the tiles 14. The stems 18 and/or spacers can be used to maintain a gap between the edge portions 24.

The wedge 12 has a distal bearing surface that bears on the edge portions 24 when the wedge 12 is driven into the opening 22. The wedge 12 has a proximal sloped surface 26 that diverges from the distal bearing surface and that bears against the bridge member 20 so that the wedge 12 can be driven into the opening 22 such that the distal bearing surface applies pressure to the edge portions 24.

The wedge 12 is generally rectangular in plan view and includes body 28 with opposed major planar side walls 30, a planar front wall 32 and a planar rear wall 34. The rear wall 34 is shaped to define a handling formation 36 to facilitate manipulation of the wedge 12. A proximal wall 38 extends from the rear wall 34 to the front wall 32 and spans the side walls 30 to define the proximal surface 26. The proximal wall 38 further defines a series of laterally extending ridges 38.

The stems 18 and the bridge member 20 are shaped so that the opening 22 is generally rectangular or square to correspond with a profile of the wedge 12. The bridge member 20 also defines a distally facing edge 40, the edge 40 and the ridges 38 being configured to interlock or engage each other as the wedge 12 is driven into the opening 22.

Conveniently, the wedge 12 and the tile laying device 10 are moulded of a plastics material.

In use, the tiles 14 are laid on a substrate, appropriately coated with tile adhesive, with the flange of the device 10 positioned in the adhesive. The edge portions 24.1, 24.2 are positioned on the front and rear portions, respectively, of the flange. The wedge 12 is then driven into the opening 22, as shown in FIG. 1. This serves to level the tiles 14 with respect to each other. The stems 18 and/or the spacers referenced above serve to maintain an appropriate gap 42 between the tiles 14. Once the adhesive has set, the stems 18 can be broken off the flange. That can be achieved by having zones of weakness in the stems 18 at appropriate positions. Once the gap 42 is filled with grout or other material, the flange and the remaining portions of the stems 18 are covered.

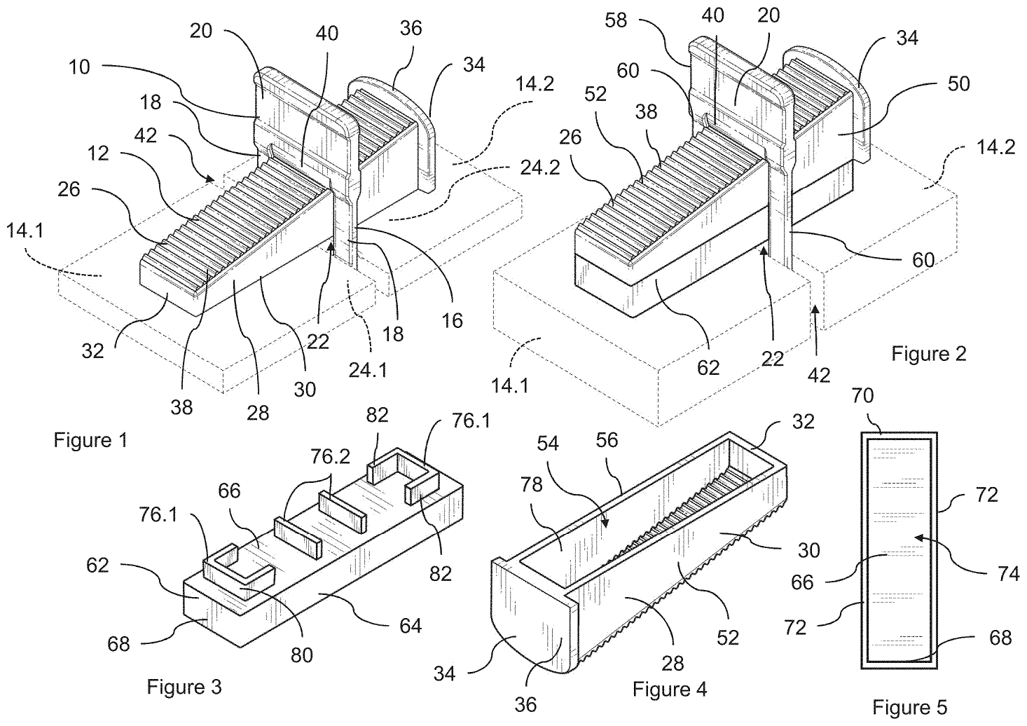

In FIG. 2, reference numeral 50 generally indicates an embodiment of a tile laying accessory, in accordance with one aspect of the invention, for the tile laying device 10, or other similar tile laying devices which include stems and a bridge portion, such as those described with reference to the tile laying device 10. In the following description, the use of reference numerals used with respect to FIG. 1 is simply for convenience and to facilitate understanding. Thus, such use is not intended to limit the scope of the appended claims. Furthermore, the use of those reference numerals is not intended to indicate that components having the same reference numerals are identical.

The tile laying accessory 50 includes a levelling member in the form of a wedge 52. The wedge 52 has been numbered with the reference numerals used for the wedge 12, described above. This is simply to indicate that the wedges 12, 52 have common characteristics, which are identifiable by common reference numerals. The use of such common reference numerals is not intended to indicate that the wedge 52 is the same as the wedge 12.

The walls 30, 32, 34 of the wedge 52 define a recess or cavity 54, as can be seen in FIG. 4. Furthermore, bottom edges of the walls 30, 32, 34 define a generally planar surface 56 into which the cavity 54 opens. Thus, the proximal surface 26 diverges from the surface 56 and the wedge 52 can be used in the same manner as the wedge 12, as described above.

In some cases, the tiles 14 can be of varying thicknesses. For example, the tiles 14 in FIG. 2 are thicker than those in FIG. 1. This can be the case where the tiles 14 are pavers, or other building components that are generally thicker than tiles that are used indoors, for example in bathrooms and kitchens. In this case, a tile laying device 58 can be supplied with stems 60 that are significantly longer than the stems 18 of the device 10, with the remaining characteristics being identical or similar.

However, the stems 60 may still be too long for the wedge 52 to be used effectively. That is, the distally facing edge 40 of the bridge member 20 may be too far away from the tiles 14 for the proximal sloped surface 26 to engage the edge 40. Also, it may be inconvenient for a tiler to seek out tile laying devices with stems of different lengths to suit different thicknesses of tile.

Thus, the accessory 50 includes a spacing block 62 that can be positioned underneath the wedge 52 to bring the sloped surface 26 into engagement with the edge 40. The spacing block 62 is releasably engageable with the wedge 52 so that the accessory 50 can be used repeatedly without having to make use of a separate component, such as a piece of timber, or the like, to provide the required spacing. The spacing block 62 can be provided in different sizes to suit different thicknesses of tiles or building components. Furthermore, two or more spacing blocks 62 can be used, where required. Thus, the spacing block 62 is configured so that it can be releasably engageable with a further spacing block 62. For example, the spacing block 62 can be configured similarly to a building block, such as that known as Lego® building blocks.

The spacing block 62 has a body 64. The body 64 is generally rectangular in plan view, i.e. when viewed proximally. The body 64 has a proximal wall 66, opposed front and rear walls 68, 70, which define minor sides of the body 64, and side walls 72, which define major sides of the body 64. The walls 66, 68, 70 define a cavity 74 (FIG. 5). The cavity 74 has dimensions that are similar to those of the cavity 54.

One or more projections 76 extend proximally from the proximal wall 66. The projections 76 include opposed end projections 76.1 that are configured to engage an internal surface 78 of the wedge 52 at respective ends of the wedge 52. Each end projection 76.1 includes a lateral wall 80 that engages the internal surface 78 at the associated front or rear wall 68, 70. Each end projection 76.1 includes opposed longitudinal walls 82, extending from the lateral walls 80, respectively, that engage the internal surface 78 of the side walls 72. The projections 76 also include two spaced intermediate projections 76.2 that are positioned intermediate the end projections 76.1 to engage the internal surface 78 of respective side walls 72. The projections 76 and the cavity 54 are dimensioned so that the engagement is frictional, such that, when the spacing block 62 is engaged with the wedge 52, the accessory 50 can be used repeatedly without the spacing block 62 becoming disengaged.

As set out above, the cavity 74 has dimensions similar to those of the cavity 54. Thus, two or more spacing blocks 62 can be releasably engaged with each other, and with the wedge 52, depending on requirements.

Furthermore, the spacing blocks 62 can be provided with different heights to suit different applications.

The accessory 50 enables a user to engage appropriately dimensioned spacing block(s) 62 with the wedge 52 prior to a particular task. Usually, the task will entail the use of building components or tiles that are all of a similar size. Thus, the user can use the accessory 50 without having to position a spacer, such as a piece of timber, underneath the wedge 52, every time the accessory 50 is used. Given that the tile laying device is used with most of the gaps between the tiles or building components, the use of a single component, in the form of the accessory 50, can be significantly more efficient and therefore cost-effective, than using two or more components with each tile laying device.

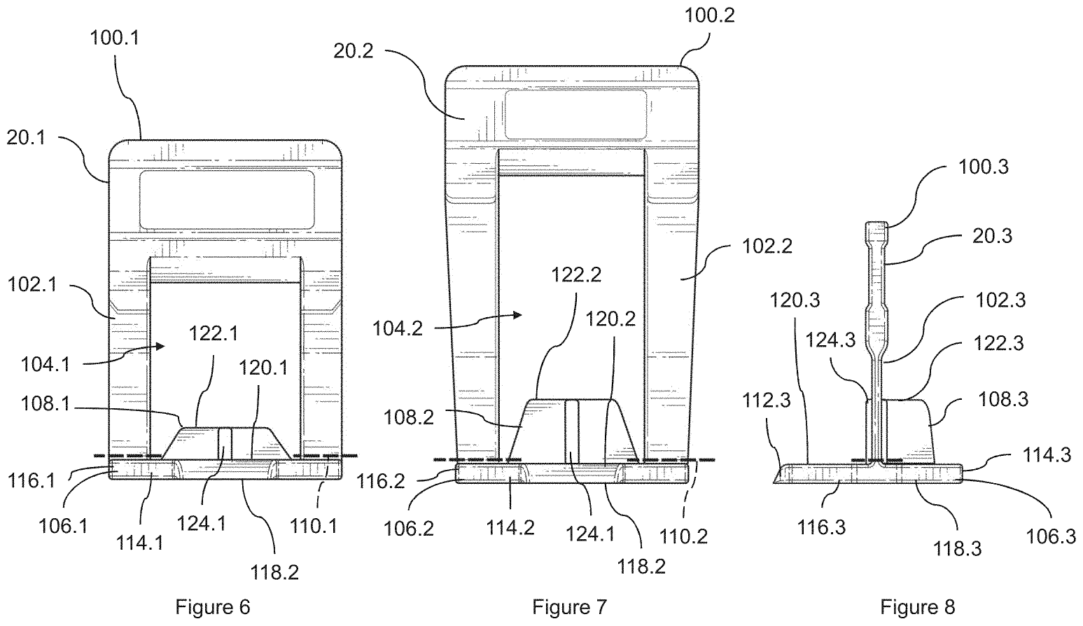

In FIGS. 6 to 9, reference numeral 100 generally indicates an embodiment of a tile laying device, in accordance with the invention. With reference to the preceding drawings, like reference numerals refer to like parts, unless otherwise specified. However, the use of such common reference numerals is only for convenience and ease of understanding and is not intended to indicate that the associated parts are identical. Furthermore, the use of such common reference numerals is not intended to limit the scope of the appended claims.

The tile laying devices 100.1, 100.2 and 100.3 shown in FIGS. 6 to 8 have different heights so that they can be used with tiles or building components having different thicknesses, in the manner described above. Stems 102 of the respective devices 100 are of different lengths such that respective openings 104 are of different sizes. As can be seen in this example, the device 100.2 would be used with tiles or building components that are thicker than those that would be used with the device 100.1 or 100.3. The device 100.1 would be used with tiles or building components that are thicker than those that would be used with the device 100.3.

The stems 102 extend from a flange 106. The bridge member 20 interconnects proximal ends of the stems 102. The stems 102 each have a rectangular cross-section along their respective lengths. Thus, each stem 102 can be bisected by a plane positioned on an axis 110 that extends through the stems 102.

The flange 106 has a front 112, a rear 114 and opposed sides 116. The flange 106 has a planar bottom surface 118 and a planar top surface 120.

A spacing formation 108 extends proximally from the flange 106, between the stems 102. The spacing formation 108 has a lateral wall 122 that extends along the axis 110 so that the axis 110 bisects the lateral wall 122. The lateral wall 122 has a thickness that is larger than that of the stems 102. The spacing formation 108 has a longitudinal wall 124 that extends orthogonally with respect to the lateral wall 122 and relative to a region halfway between ends of the lateral wall 122. The walls 122, 124 can have the same thickness. The spacing formation 108 can be in the form of an integral one-piece structure. Alternatively, the lateral wall 122 and the longitudinal wall 124 can be separate from each other.

The device 100 can be in the form of an integral one-piece structure. For example, the device 100 can be in the form of a one-piece moulding of a plastics material.

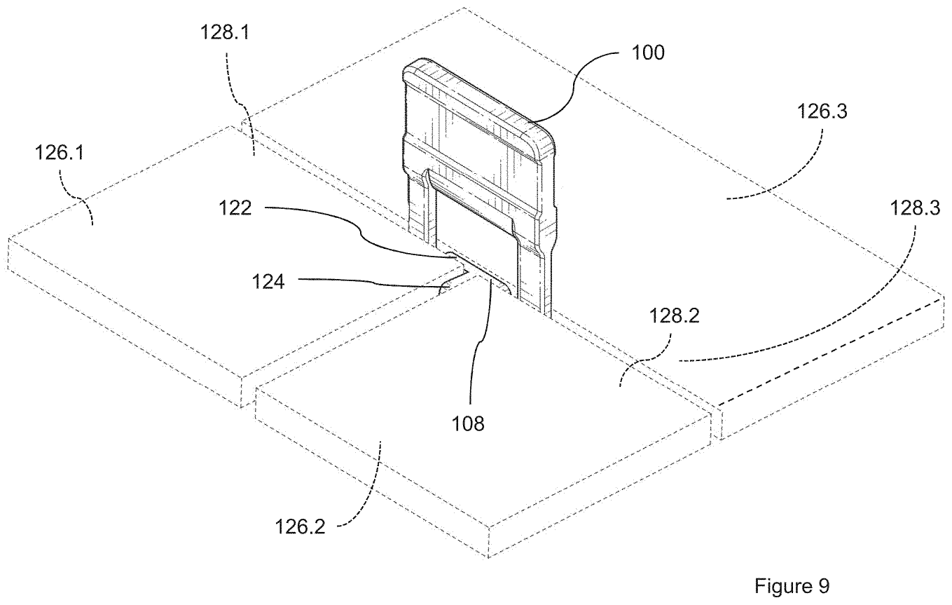

The way in which the device 100 is used is illustrated in FIG. 9. The device 100 is intended for use with three adjacent tiles or building components 126. Two of the tiles 126.1, 126.2 have edge portions 128.1, 128.2 that are located on a rear portion 130 of the flange 106. The tiles 126.1, 126.2 are positioned so that the longitudinal wall 124 is positioned between the tiles 126.1, 126.2. Another of the tiles 126.3 is positioned on a front portion 132 of the flange 106. The tiles 126 are manipulated towards each other so that the longitudinal wall 124 defines a spacing or gap 134 between the tiles 126.3 and each of the tiles 126.1, 126.2, and the lateral wall 122 defines a spacing or gap 136 between the tiles 126.1, 126.2. As with the previous embodiments and the tile laying device 10, the flange 106 is positioned in the tile adhesive that is used to adhere the tiles 126 to a substrate. The fact that at least the wall 122 is thicker than the stems 102 allows the stems to be detached from the flange 106, in the manner described above, without being locked or held between the tiles 126. Also, as before, once the gaps 134, 136 are filled with grout, or the like, the flange 106 and any remaining portions of the stems 102 are covered and are not visible.

Thus, the device 100 provides a convenient means for tiling with tiles or building components where at least two of the tiles or building components have different surface areas.

For convenience, where a number “x” is provided with a suffix, such as “x.1”, “x.2”, “x.3”, etc., in the drawings, reference to the number “x” without the suffix in the description is to be regarded as a collective reference to those numbers with the suffix.

The word “proximal” and its derivatives is intended to indicate a position or orientation that would be closer to a user of the tile laying device, as described above, than a position or orientation that would be referred to by the word “distal” and its derivatives.

The appended claims are to be considered as incorporated into the above description.

Throughout this specification, reference to any advantages, promises, objects or the like should not be regarded as cumulative, composite and/or collective and should be regarded as preferable or desirable rather than stated as a warranty.

Throughout this specification, unless otherwise indicated, “comprise,” “comprises,” and “comprising,” (and variants thereof) or related terms such as “includes” (and variants thereof),” are used inclusively rather than exclusively, so that a stated integer or group of integers may include one or more other non-stated integers or groups of integers.

It is to be understood that the terminology employed above is for the purpose of description and should not be regarded as limiting. The described embodiments are intended to be illustrative of the invention, without limiting the scope thereof. The invention is capable of being practised with various modifications and additions as will readily occur to those skilled in the art.

When any number or range is described herein, unless clearly stated otherwise, that number or range is approximate. Recitation of ranges of values herein are intended to serve as a shorthand method of referring individually to each separate value falling within the range, unless otherwise indicated herein, and each separate value and each separate subrange defined by such separate values is incorporated into the specification as if it were individually recited herein.

Words indicating direction or orientation, such as “front”, “rear”, “back”, etc, are used for convenience. The inventor(s) envisages that various embodiments can be used in a non-operative configuration, such as when presented for sale. Thus, such words are to be regarded as illustrative in nature, and not as restrictive.

The term “and/or”, e.g., “A and/or B” shall be understood to mean either “A and B” or “A or B” and shall be taken to provide explicit support for both meanings or for either meaning.

1. An accessory for a tile laying device that has a flange on which edge portions of two or more adjacent tiles can be positioned and a web that extends from the flange, the web defining an opening, the accessory comprising:
a levelling member that defines a proximal surface and a distal surface, the proximal surface being configured to diverge from the distal surface so that, when the levelling member is positioned in the opening of the web and the edge portions are positioned on the flange, displacement of the levelling member relative to the tile laying device results in the distal surface bearing against the edge portions; and
a spacing block that can be interposed between the distal surface of the levelling member and the edge portions of the two or more adjacent tiles, the spacing block and the levelling member being releasably engageable with each other.

2. The accessory as claimed in claim 1, wherein the spacing block is configured so that it can be releasably engageable with a further spacing block.

3. The accessory as claimed in claim 2, wherein the levelling member defines one or more recesses that open in the distal surface and the spacing block has a body with one or more projections extending from a proximal side of the body.

4. The accessory as claimed in claim 3, wherein the one or more recesses of the levelling member and the one or more projections of the spacing block are dimensioned so that the one or more projections can be press-fitted, by hand, into the one or more recesses and extracted, by hand, from the one or more recesses.

5. The accessory as claimed in claim 4, wherein:
the levelling member defines a single recess in the form of a cavity;
the levelling member and the spacing block are both rectangular in plan with opposed minor sides and opposed major sides;
the projections of the spacing block include opposed end projections that are positioned to engage an internal surface of the levelling member at respective ends of the levelling member; and
the projections of the spacing block include opposed intermediate projections that are positioned intermediate the end projections to engage the internal surface of respective opposite major sides of the levelling member.
